(19) United States
(12) Patent Application Publication
(10) Pub. No.: US 2014/0124644 A1
(43) Pub. Date: May 8, 2014

(54) CRADLE ASSEMBLY FOR A TABLET

(71) Applicant: Avionics Support Group, Inc., Miami, FL (US)

(72) Inventors: Armand A. Wong, Miami, FL (US); Alejandro J. Rodrigo, Miami, FL (US); Hugo L. Fortes, Miami, FL (US)

(73) Assignee: Avionics Support Group, Inc., Miami, FL (US)

(21) Appl. No.: 14/032,285

(22) Filed: Sep. 20, 2013

Related U.S. Application Data
(60) Provisional application No. 61/721,625, filed on Nov. 2, 2012.

(51) Int. Cl. B64D 43/00

(52) U.S. Cl. CPC B64D 43/00
USPC 248/553; 29/428; 248/222.14; 248/551

(57) ABSTRACT

A cradle assembly for supporting a tablet or other electronic device, such as in the cockpit of an aircraft. The cradle assembly includes a tablet retention assembly, a locking assembly to secure the tablet within the cradle assembly, a docking assembly for cooperating with the tablet and an optional integrated power supply. The tablet retention assembly includes a slideable plate that moves longitudinally relative to the main cradle assembly body to securely support the tablet.

### CROSS REFERENCE TO RELATED APPLICATIONS

This application claims the benefit of and priority to U.S. Provisional Patent 61/721,625, filed Nov. 2, 2012, which is incorporated in its entirety in this document by reference.

### FIELD OF THE INVENTION

The present invention generally relates to a cradle assembly for securely supporting a tablet or other electronic device, such as in the cockpit of an aircraft.

### BACKGROUND OF THE INVENTION

In the aviation industry, it is desirable to permit user interface with a tablet or other electronic device within the confines of a cockpit and to provide support for the tablet that may be secured. It is also desirable to provide a tablet support which is configured to tolerate specific conditions and limitations, such as those presented in the cockpit of an aircraft.

When used in a cockpit of an aircraft, electronic devices must be positioned within the cockpit so as not to obstruct visibility. It is therefore necessary to provide a tablet support which allows the aircraft pilot to have an unobstructed view through the window during taxiing, and any critical phase of flight. Moreover, the pilot must be able to change the viewing angle of the tablet during aircraft maneuvers to accommodate varying glare on the display with one hand while maintaining control of the aircraft with the other hand. Therefore, it is desirable to provide a cradle assembly for a tablet and a mount for the cradle assembly which does not require levers, adjustment screws, or pressure switches to change the viewing angle. This and other objectives are met by the present invention.

### SUMMARY OF THE INVENTION

In accordance with preferred embodiments of the present application, the present application obviates shortcomings of the prior art by providing a tablet or other electronic device cradle assembly which safely supports the device in prescribed conditions, such as conditions present in the cockpit of an aircraft. Additionally, the cradle assembly includes a locking system to prevent unintentional or unauthorized removal of the device from the cradle assembly. Moreover, the cradle assembly may accommodate devices having different configurations or dimensions. The cradle assembly also enables cooperation with an integrated power supply and/or an external power source to the tablet or electronic device through the provision of a connector docking assembly.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1 is a front perspective view of a cradle assembly according to a one embodiment of the present application, showing a tablet coupled to a mount with the cradle assembly;

FIG. 2 is a perspective view of the cradle assembly of FIG. 1;

FIG. 3 is an exploded view of the cradle assembly of FIG. 1, according to one aspect;

FIG. 4 is an elevational view showing the first face of a main body of the cradle assembly of FIG. 1;

FIG. 5 is an elevational view showing the second face of the main body of the cradle assembly of FIG. 1;

FIG. 6 is a perspective view of a tablet retention assembly of the cradle assembly of FIG. 1;

FIG. 7 is an elevational view of a portion of a locking assembly of the cradle assembly of FIG. 1.

FIG. 8 is a perspective view of the docking assembly of the cradle assembly of FIG. 1, according to one aspect;

FIG. 9 is a perspective view of the docking assembly of the cradle assembly of FIG. 1, according to one aspect;

FIG. 10 is a perspective view of an integrated power supply and docking assembly of the cradle assembly of FIG. 1, according to one aspect;

FIG. 11 is an elevational view of a cradle assembly, showing the first face of a main body of the cradle assembly, according to one aspect;

FIG. 12 is an elevational view of the cradle assembly of FIG. 11, showing the second face of the main body;

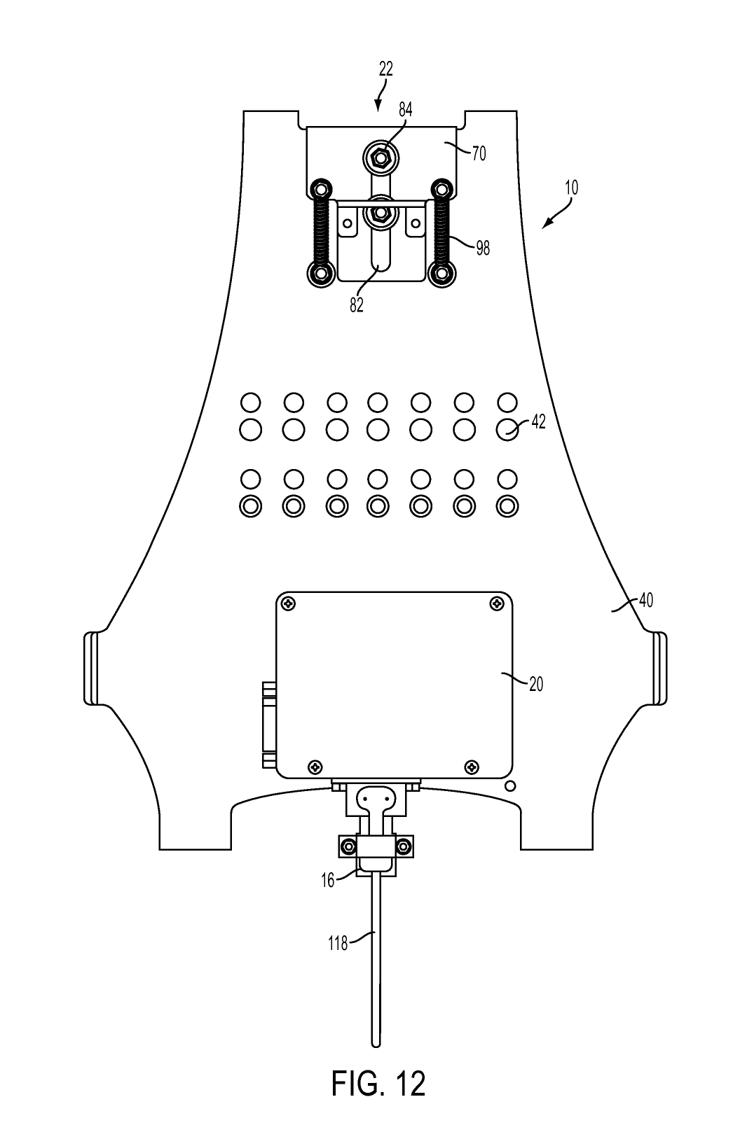

FIG. 13 is an exploded view of the cradle assembly of FIG. 11;

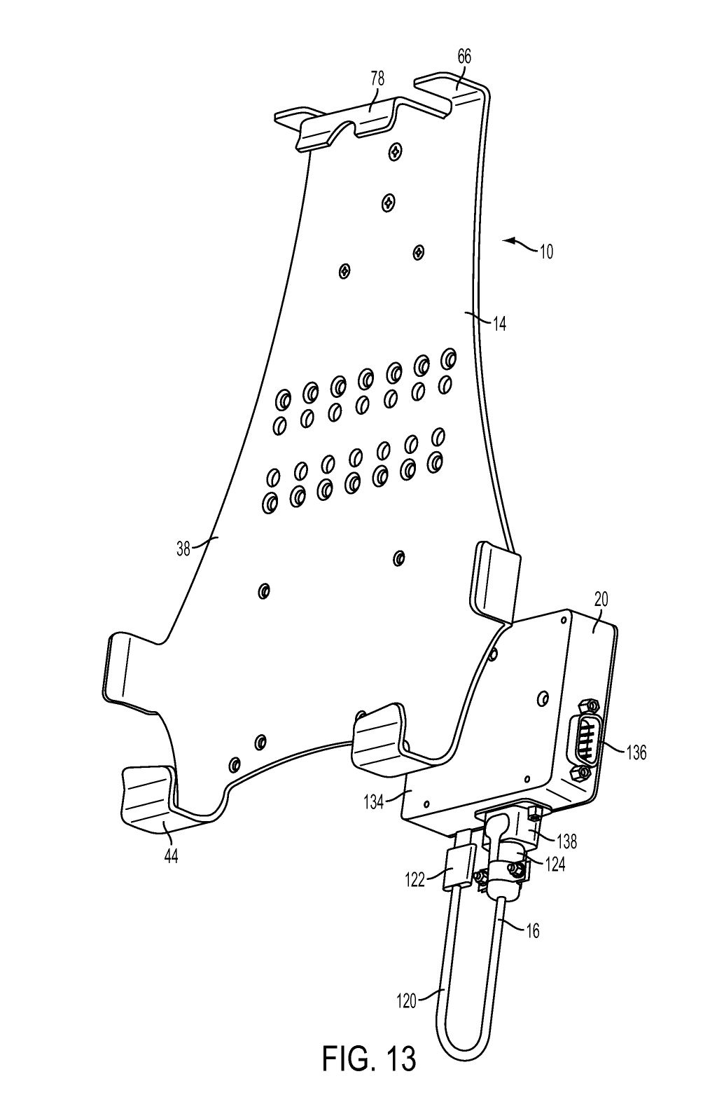

FIG. 14 is an elevational view of a cradle assembly according to one aspect, showing the first face of a main body of the cradle assembly, wherein a plurality of ports of an integrated power supply of the cradle assembly are adjacent a distal edge of the main body;

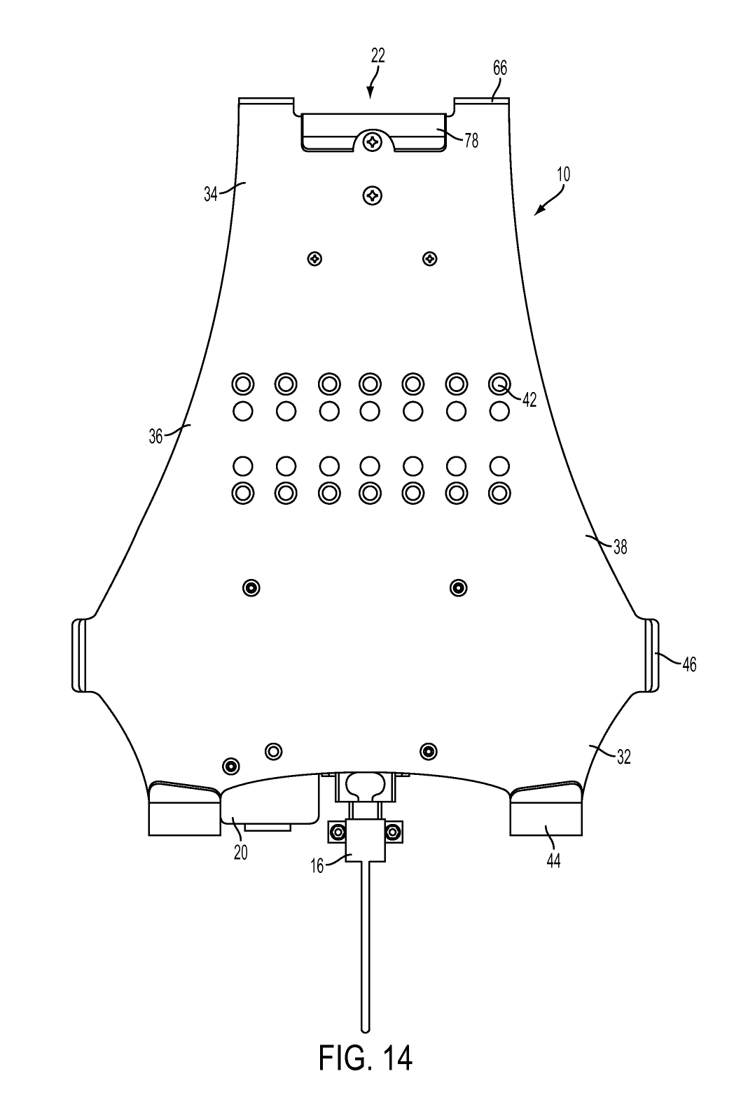

FIG. 15 is a elevational view of the cradle assembly of FIG. 14, showing the second face of the main body;

FIG. 16 is an exploded view of the cradle assembly of FIG. 14;

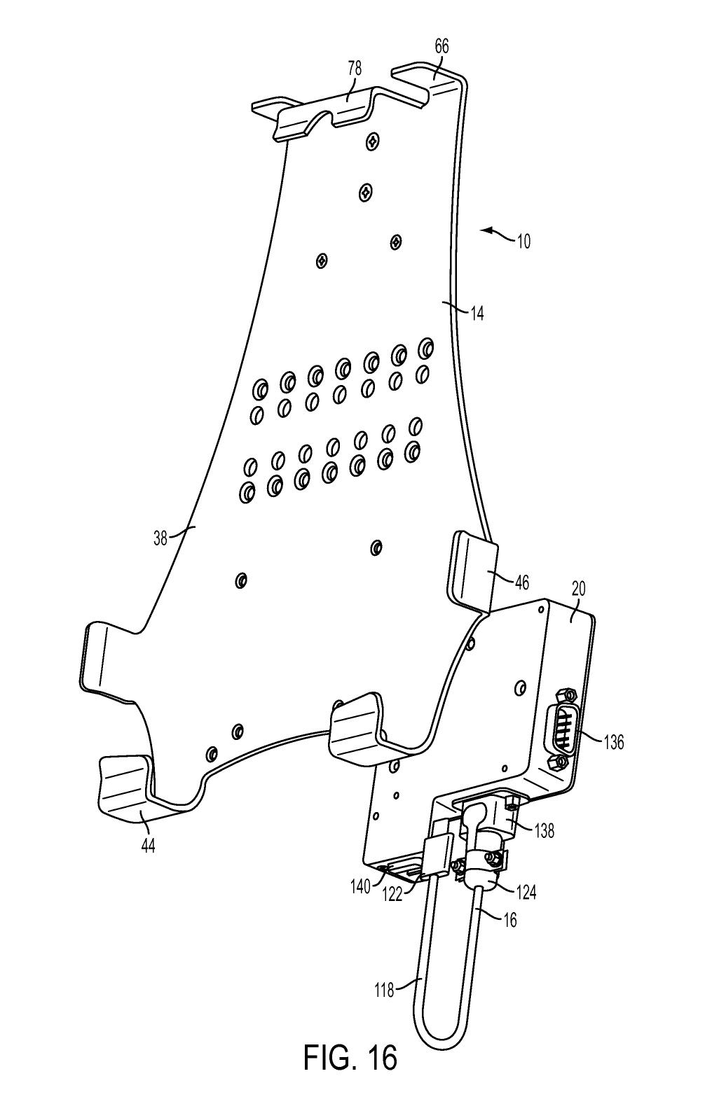

FIG. 17 is an elevational view of a cradle assembly, showing the first face of a main body of the cradle assembly, according to one aspect;

FIG. 18 is an exploded view of the cradle assembly of FIG. 17; and

FIG. 19 is an elevational view of the cradle assembly of FIG. 17, showing the second face of the main body.

### DETAILED DESCRIPTION OF THE INVENTION

The present systems and apparatuses and methods are understood more readily by reference to the following detailed description, examples, drawing, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a” component can include two or more such components unless the context indicates otherwise. Also, the words “proximal” and “distal” are used to describe items or portions of items that are situated closer to and away from, respectively, a user or operator such as a pilot. Thus, for example, the tip or free end of a device may be referred to as the distal end, whereas the generally opposing end or handle may be referred to as the proximal end.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

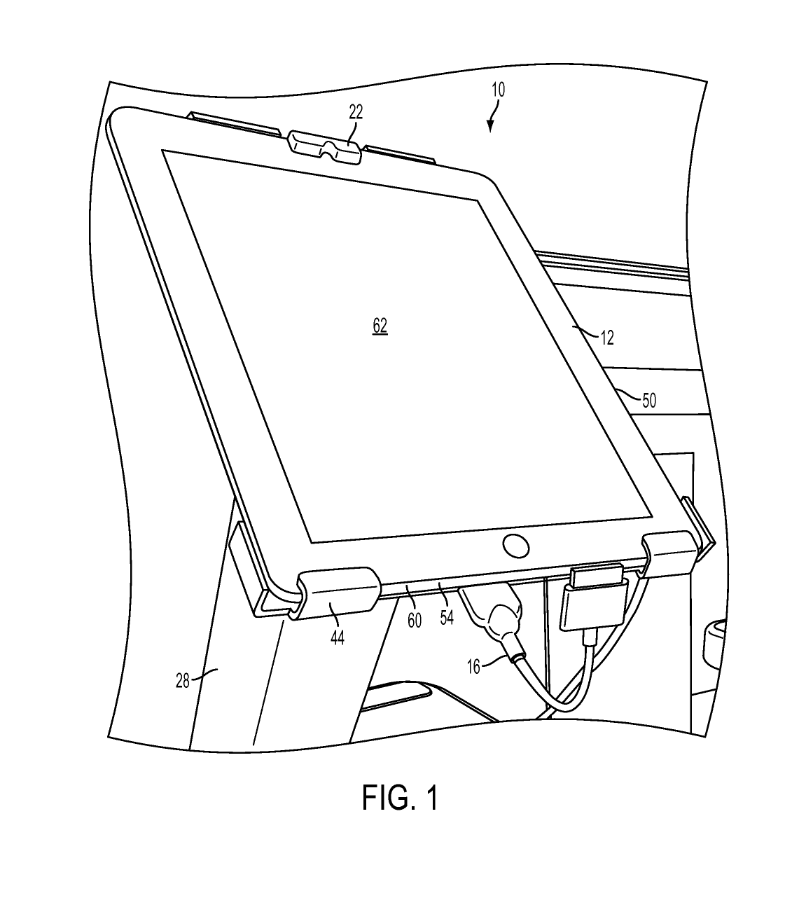

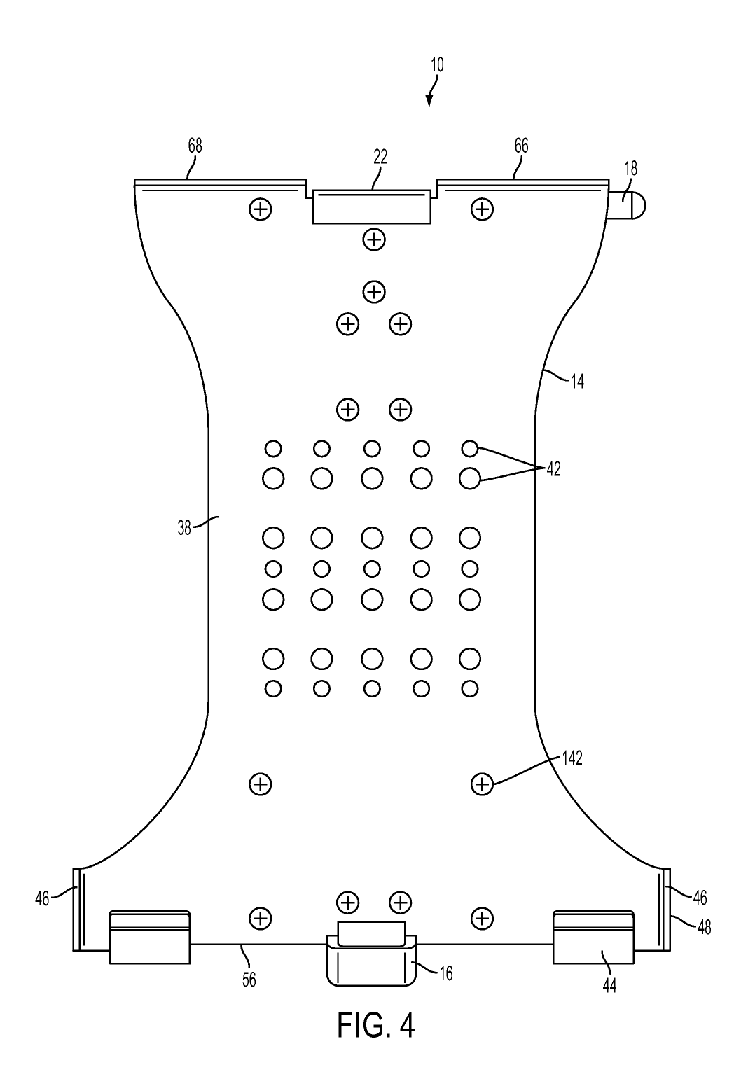

As shown in FIGS. 1-4, the cradle assembly 10 for a tablet 12 comprises at least one of: a main body 14 or support; a docking assembly 16; a locking assembly 18; an integrated power supply 20; and a selectively adjustable tablet retention assembly 22. In use, the main body can support the tablet. The retention assembly can retain the table in the desired location relative to the main body. In one aspect, the locking assembly can prevent or restrict unauthorized removal of the table from the cradle assembly. The docking assembly can couple the tablet 12 to a power source and/or a data interface for the tablet 12. In another aspect, the integrated power supply can supply power to the tablet. The tablet retention assembly 22 includes a first mating member 24 which can cooperate with at least one second mating member 26 as explained more fully below.

Referring to FIG. 1, the cradle assembly 10 can be configured to support a tablet 12 or other electronic device. For the sake of convenience and clarity, use of the term “tablet” herein refers to all forms of electronic devices, collectively, such as cellular phones, laptop computers, tablet computers, televisions, and the like. It can be desirable for pilots of an aircraft to have ready access to tablets within the cockpit. The tablets, however, must be readily viewed by the pilot and yet mounted so as not to interfere with the flight controls. In one aspect, the cradle assembly 10 can be used in combination with a mount 28 such as, for example and without imitation, a constant swivel mount of U.S. Pat. No. 7,686,250 and U.S. Pat. No. 8,231,081, the disclosures of which are incorporated herein by reference.

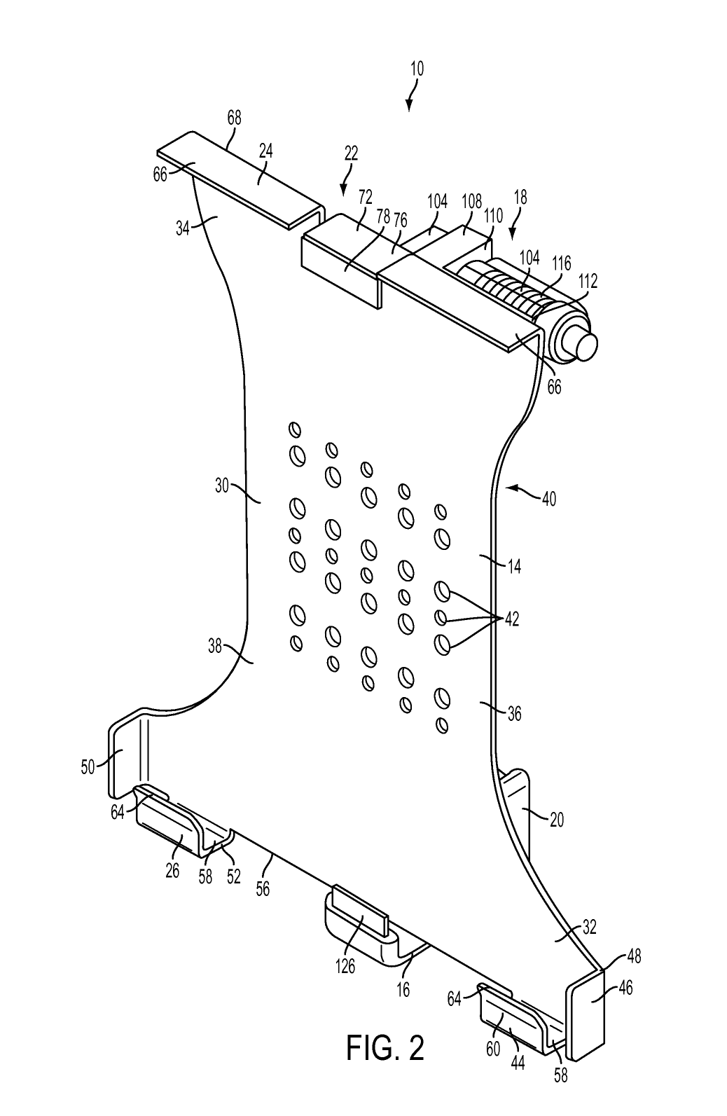

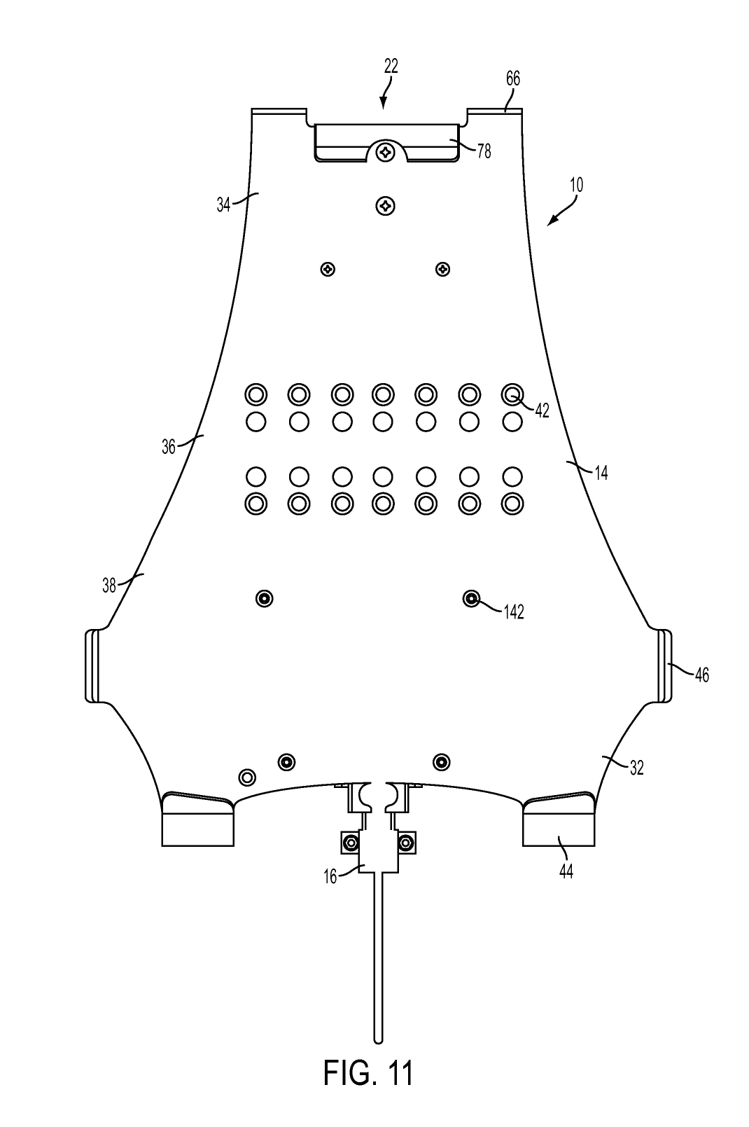

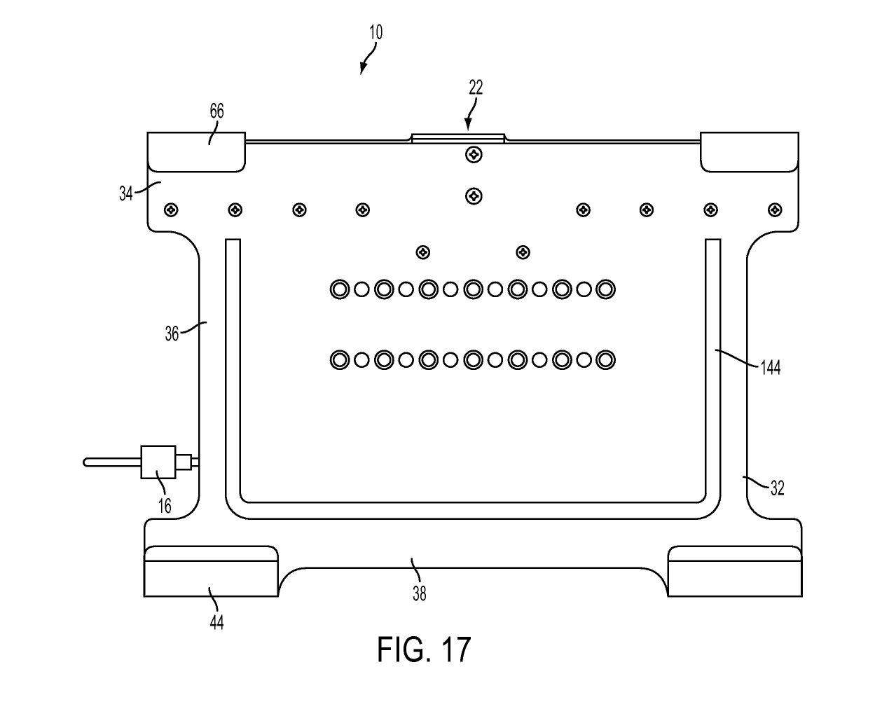

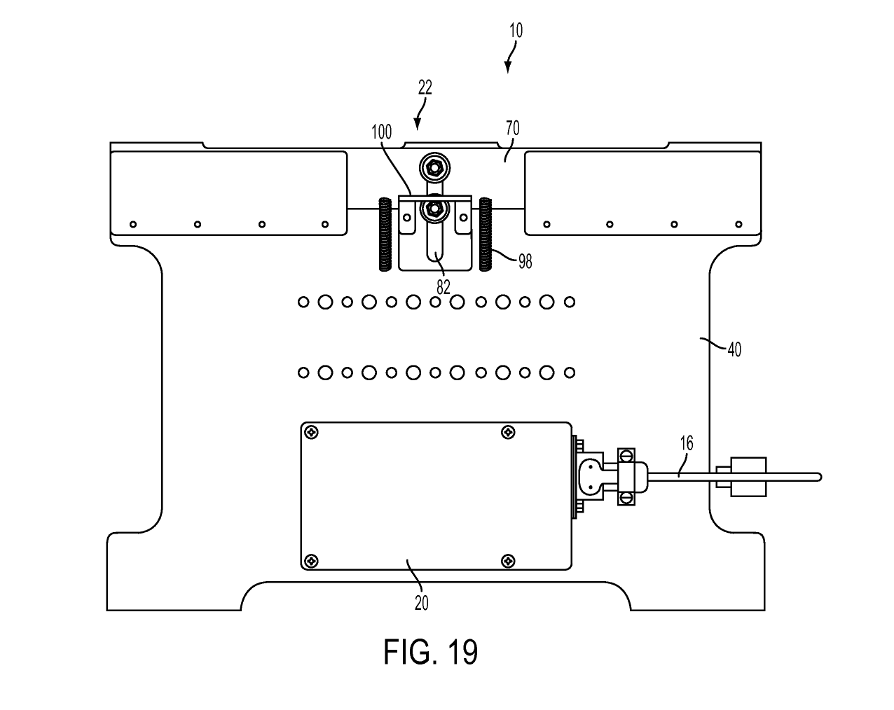

As illustrated at least in FIGS. 2, 4 and 11, in one aspect, the main body 14 or support can be a longitudinally extending body (i.e., the main body extends along a longitudinal axis) having a laterally extending first section 32 and a laterally extending second section 34. As such, the main body 14 can have a middle section 36 positioned between the first section and the second section. In one aspect, the middle section can have a narrower longitudinal width than at least one of the first section 32 and the second section 34. In another aspect, the first section of the main body can be wider than, substantially equal to, or narrower than the second section and/or the middle section 36 of the main body 14. It is to be understood, however, that different configurations are also within the scope of the present application. For example, a rectangular-shaped main body may also be provided, as illustrated in FIGS. 17-19. In one aspect, the main body 14 can have a first face 38 and an opposed second face 40. The first face and/or the second face can be substantially planar though it is contemplated that at least one of the first face 38 and the second face 40 need not be substantially planar.

In one aspect, a plurality of body apertures 42 can be defined in a portion of the main body 14 such that the plurality of body apertures are arranged in a predetermined configuration as shown in the various Figures. However, it is contemplated that the plurality of body apertures 42 can also be arranged in other configurations not illustrated. The plurality of body apertures 42 can provide means for cooperating with the aforementioned mount 28 wherein the cradle assembly 10 may be secured thereto by at least one fastener such as a bolt, screw and the like. That is, the fastener can extend through at least one body aperture of the plurality of body apertures 42 to couple the main body 14 to the mount. It is contemplated, however, that the main body can be coupled to the mount 28 with other means. For example, the main body 14 could be adhered to the mount with adhesives. In another example, the main body could be formed integrally with the mount 28. Moreover, the plurality of body apertures 42 can provide ventilation for the tablet mounted therein and for operation of the tablet retention assembly 22 as described below.

The main body 14 can include at least one receptacle member 44 positioned adjacent the first face 38 of the first section 32 of the main body 14 and configured to support a portion of the tablet. As shown in FIG. 2, the at least one receptacle member 44 can include at least one longitudinally extending lateral arm 46 positioned along a lateral edge 48 of the first section 32 of the main body 14 for engaging a second perimeter edge 50 of the tablet 12. That is, at least a portion of the lateral arm can extend beyond the first face 38 of the main body to prevent or restrict lateral movement of a tablet 12 positioned in the cradle assembly 10.

In one aspect, the at least one receptacle member 44 of the main body 14 can include at least one longitudinally extending bottom extension member 52 for supporting a first perimeter edge 54 of the tablet 12. In another aspect, a portion of the at least one bottom extension member 52 can be coupled to and extend from a distal edge 56 of the first face 38 of the main body 14 and can include a supporting surface 58 positioned at a first angle relative to the first face 38 of the main body. The first angle can be substantially 90 degrees, however, it is contemplated that the first angle can be less than or greater than about 90 degrees. In this aspect, the supporting surface can be configured for contacting and supporting at least a portion of the first perimeter edge 54 of the tablet 12.

In another aspect, a portion of at least one retaining member 60 can be coupled to and extend from the bottom extension member 52 at a second angle. The second angle can be substantially 90 degrees, however, it is contemplated that the second angle can be less than or greater than about 90 degrees. In this aspect, at least a portion of the at least one retaining member 60 can be configured for contacting a viewing side 62 of the tablet. In a further aspect, at least a portion of the at least one retaining member 60 can be positioned at an acute angle relative to the bottom extension member 52, so as to define an outwardly extending lip 64 to facilitate insertion and removal of the tablet 12 into the cradle assembly 10.

In one aspect, the second section 34 of the main body 14 includes at least one laterally extending retention member 66. The least one retention member can be coupled to and extend from a proximal edge 68 of the first face 38 of the main body 14. For example, the at least one retention member can extend from the proximal edge at a third angle of about 90 degrees relative to the first face of the main body. In other example, the third angle can be less than or greater than about 90 degrees. In use, the at least one retention member can limit or prevent longitudinal movement of the tablet 12 relative to the main body 14.

In one aspect, the main body 14 can be formed of aviation grade aluminum and may optionally be lined with less rigid surface areas, such as felt. Although aluminum can be preferred for aviation applications, other applications may permit other materials, such as plastics, other metals and the like.

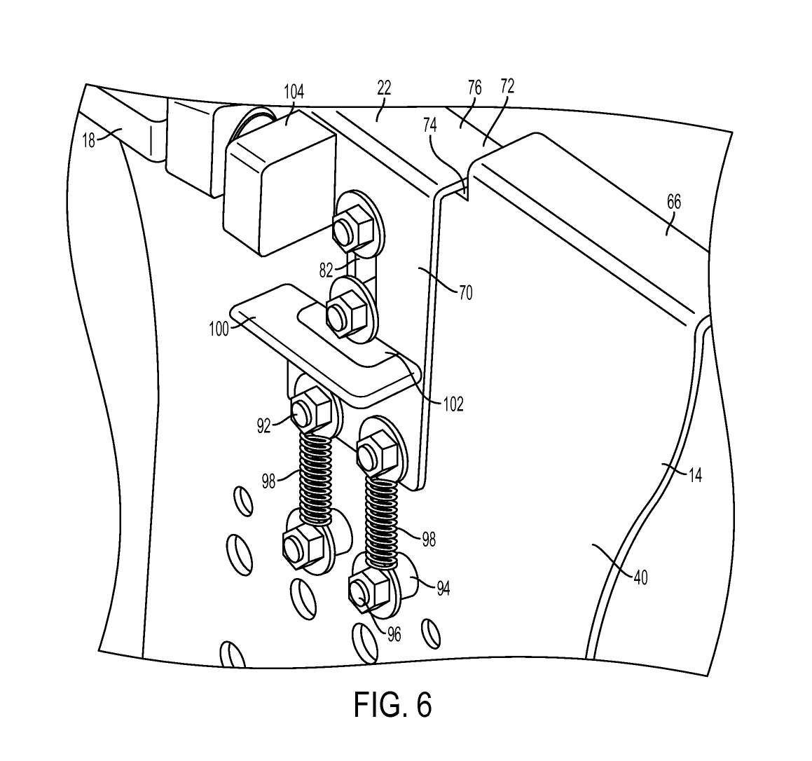

The adjustable tablet retention assembly 22, as shown at least in FIGS. 2, 5 and 6, is configured to secure the tablet 12 within the cradle assembly 10. As can be appreciated, the tablet retention assembly can be selectively adjustable to secure tablets of varying dimensions. In one aspect, the tablet retention assembly 22 can be configured to cooperate with the locking assembly 18 to allow a user to selectively lock a tablet 12 to the cradle assembly 10. In another aspect, the tablet retention assembly 22 includes a slideable plate 70 having a retaining flange 72. As described more fully below, a portion of the slideable plate can overlie the main body 14, and a portion of the slideable plate can be sized and shaped to slide longitudinally in a guide groove 74 defined in a portion of the main body. That is, the guide groove can be defined in a portion of the second section 34 of the main body so that a portion of the slideable plate can slide in the guide notch relative to the main body 14.

In one aspect, the retaining flange 72 of the slideable plate 70 includes a lateral upper surface 76 extending away from the first face 38 of the main body at a fourth angle relative to the slideable plate. For example, the upper surface can extend substantially normal to the slideable plate 70. Optionally, in other examples, the fourth angle can be less than or greater than 90 degrees so that the upper surface 76 can extend at an angle less than or great than about 90 degrees relative to the slideable plate. In another aspect, a longitudinal front lip 78 can extend at a fifth angle relative to the upper surface 76. For example, the front lip can extend substantially normal to the upper lip. Optionally, in other examples, the fifth angle can be less than or greater than 90 degrees. As such, the retaining flange 72 and the longitudinal front lip 78 of the slideable plate can cooperate to define a tablet chamber 80 configured to receive a portion of the tablet 12 therein. In use, the slideable plate can slideable between a first plate position, in which the tablet chamber is a first distance from the distal edge 56 of the main body 14, and a second plate position, in which the tablet chamber 80 is a second distance from the distal edge of the main body that is less than the first distance.

In one aspect, at least one slot 82 having a predetermined longitudinal length can be defined in a portion of the slideable plate 70. In one aspect, a slide limiting device 84, shown in the figures in the form of two screws, can extend through the at least one slot 82 to prevent the slideable plate from sliding past a predetermined position. In another aspect, the slide limiting device can slidably couple the slideable plate to the main body 14. A pair of nuts and washers can be provided to cooperate with the slide limiting device 84 to secure the slide limiting device in the desired location. As such, the slideable plate 70 can be slideable in the longitudinal direction and such movement can be limited by the predetermined dimension of the at least one slot 82 and the location of the slide limiting device 84 relative to the slot. For example, at least a portion of the slideable plate 70 can overlie the main body 14. The slideable plate can slide longitudinally relative to the main body in a first direction until the slide limiting device 84 contacts a first end 86 of the slot, and the plate can slide longitudinally in a second direction that is opposed to the first direction until the slide limiting device 84 contacts a second end 88 of the slot 82. It is within the scope of the application to provide means other than screws for cooperating with the slideable plate 70 to permit longitudinal motion of the slideable plate relative to the main body 14.

In one aspect, at least one bore 90 can be defined therein the slideable plate 70 configured for receipt of at least one plate fastener 92, such as a screw, bolt and the like. As can be appreciated, washers and/or nuts can be included to secure the plate fastener 92 to the slideable plate. In another aspect, at least one spacer 94 can be secured to the second face of the main body 14 through respective body apertures 42 of the main body with the use of at least one main body fastener 96 such as a screw, bolt and the like. Nut(s), and/or washer(s) can be included to secure the main body fastener 96 to the main body 14. At least one spring 98 can extend from each main body fastener 96 to a respective plate fastener 92. As can be appreciated, because the slideable plate 70 overlies at least a portion of the main body, the at least one spacer can be used to align at least a portion of the at least one plate fastener 92 and the at least one main body fastener 96. That is, in one aspect, the at least one spacer can align at least a portion of the at least one plate fastener 92 and the at least one main body fastener 96 such that a longitudinal axis of the at least one spring 98 is substantially parallel to the longitudinal axis of the main body 14.

In use, accordingly, the slideable plate 70 can be biased in the first direction toward the distal edge 56 of the main body 14 by the at least one spring 98 to urge against at least one perimeter edge 50, 54 of a tablet 12 positioned within the cradle assembly 10. FIG. 1 illustrates the cradle assembly wherein the slideable plate 70 is in the first, biased plate position, in which the retaining flange 72 of the slideable plate is biased closer to the distal edge 56 of the main body 14 than in the second, unbiased plate position. The tension of the at least one spring may be adjusted as desired to increase or decrease the force exerted by the slideable plate 70 onto the tablet 12.

The slideable plate 70 may be moved in the second direction against the bias of the at least one spring 98 to permit insertion of and removal of a tablet 12 and to accommodate tablets of different dimensions. In one aspect, a handle 100 can be provided to facilitate the sliding movement of the slideable plate 70 relative to the main body 14. Thus, to insert or remove a tablet, the user can pull the handle 100 in the second direction against the bias of the spring 98 (i.e., away from the distal edge 56 of the main body 14). Upon release of the handle 100, the slideable plate 70 can be biased in the first direction longitudinally toward the distal edge 56 of the main body 14, until the upper surface 76 and/or the front lip 78 of the retaining flange 72 press against a portion of the tablet. In another aspect, a passage 102 can be defined in the handle 100 to provide sufficient tolerances and clearance to cooperate with the slide limiting device 84 used to secure the slideable plate 70.

In use, the tablet 12 may be inserted into the cradle assembly 10 utilizing the handle 100 to slide the slideable plate 70 in the second direction away from the distal edge 56 of the main body 14. Upon release of the handle 100, the tablet can be secured under the bias of the at least one spring 98 as the tablet retention assembly 22 urges against at least a portion of a perimeter edge of the tablet and urges the tablet against the bottom extension member 52 of the main body 14.

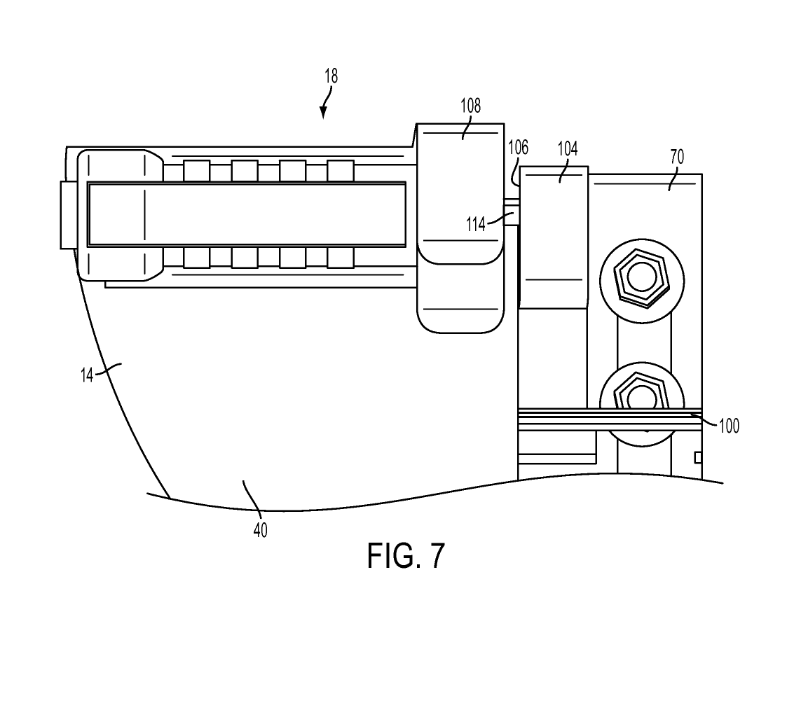

In one aspect, the slideable plate 70 further includes a locking member 104 for cooperating with the locking assembly 18. As shown in FIGS. 2, 3, 6 and 7, the locking member 104 can be in the form of an outwardly extending member defining a lock receiving cavity 106. The locking assembly 18 can be positioned on the second face 40 of the main body 14 by a lock support 108. In another aspect, the lock support 108 includes a block member 110 and a base member 112. The block member 110 and/or the base member 112 can be configured to couple the locking assembly to the main body 14 such that a locking pin 114 of the locking assembly can be substantially aligned with the lock receiving cavity 106 of the slideable plate when the slideable plate is in a predetermined position relative to the main body 14.

According to one aspect, the locking assembly 18 can be a combination lock 116, wherein the user may unlock or lock the cradle assembly 10 with a combination and no external tools are required. Therefore, when the locking assembly is in a locked position, unauthorized or unintentional removal of a tablet 12 held by the cradle assembly 10 can be precluded.

After the tablet 12 is positioned in the cradle assembly 10, the locking assembly 18 may be activated by using a key, entering a code or combination and the like. For example, if the locking assembly 18 comprises a combination lock 116, the combination lock may be activated by a user entering a required combination. In one aspect, entering the required combination can actuate the locking pin 114 to a first, extended position wherein the locking pin 114 extends from within the locking assembly 18 and into the lock receiving cavity 106 of the locking member 104. Thus, actuating the locking pin can secure the position of the slideable plate 70 relative to the main body 14 such that the slideable plate 70 is precluded from sliding longitudinally. The tablet 12 can thereby be secured within the cradle assembly 10. To remove the tablet, the required key and/or combination can be entered into the locking assembly and the locking pin 114 can be moved to a second, retracted position outside of the lock receiving cavity 106. This can release the slideable plate 70 and permit longitudinal movement of the slideable plate relative to the main body 14. As shown, a combination lock is provided, but it is within the scope of the present invention to provide a lock having different configurations including those requiring a tool or key. The locking assembly 18 may optionally be provided to the cradle assembly 10.

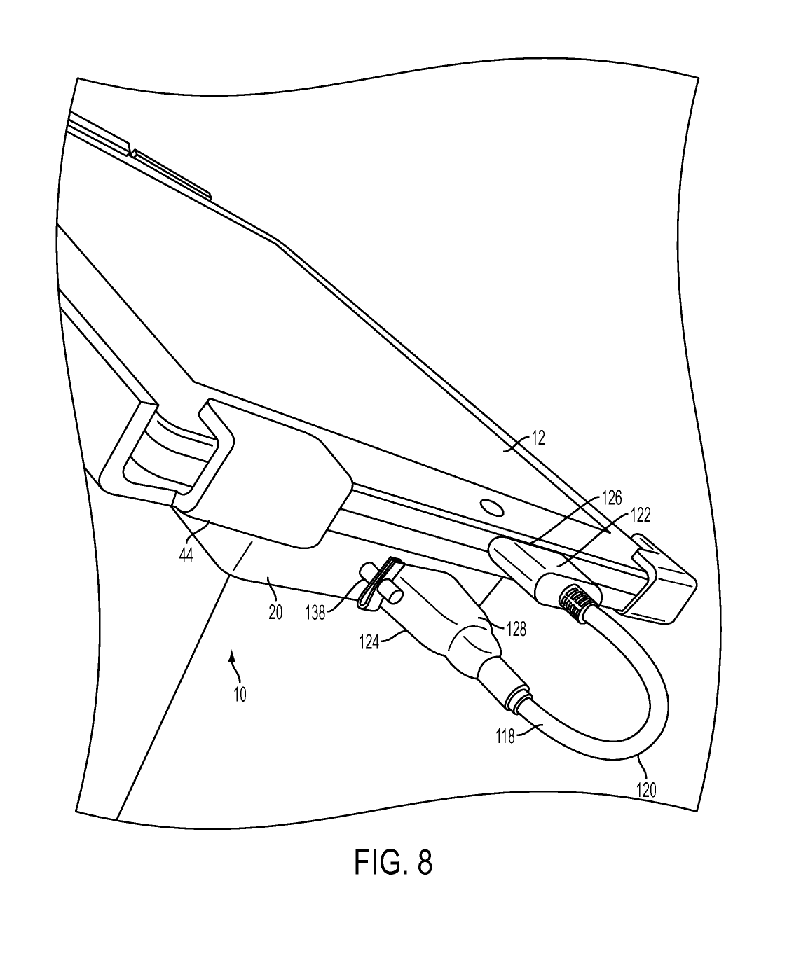

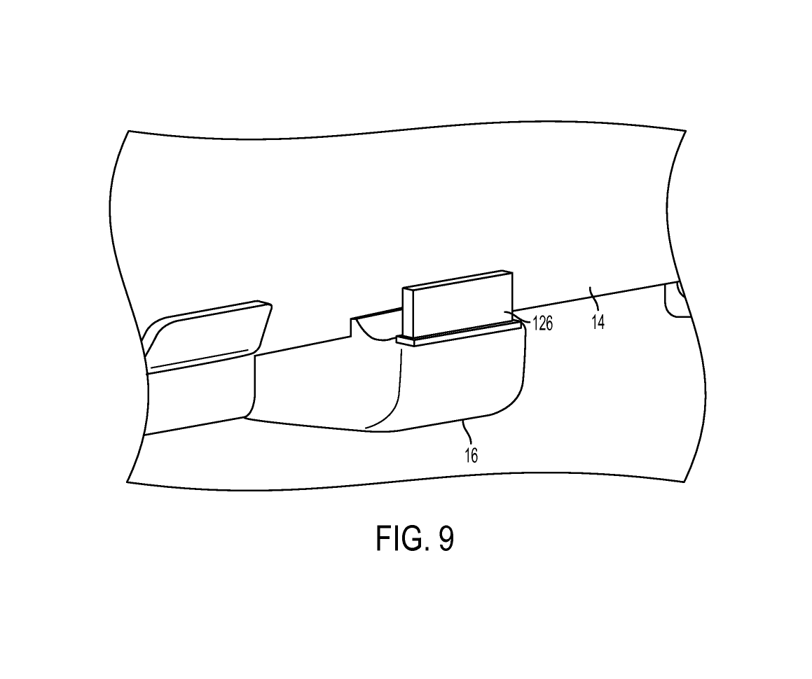

The docking assembly 16 is shown in FIGS. 1-5 and 8-10, according to various aspects. The docking assembly can couple a power source and/or a data interface having a hardware connection to the tablet 12. In one aspect, the docking assembly 16 can comprise an adapter cable assembly 118 configured to couple the tablet to the integrated power supply 20 as illustrated in FIG. 8. For example, if the tablet 12 is an iPad produced by Apple, Inc. of Cupertino, Calif., the adapter cable assembly 118 can comprise a cable 120 have a first end 122 configured to couple to the iPad, and a second end 124 configured to couple to the integrated power supply 20. In another aspect, the first end 122 of the cable can comprise a tablet port 126 configured to couple to any desired tablet and the second end 124 of the cable can comprise a power supply port 128 configured to couple to the integrated power supply 20. In a further aspect, the adapter cable assembly 118 can comprise a plurality of cables 120. In this aspect, the first end 122 of each cable can be configured to couple to a different type of tablet. Thus, tablets having connection ports with varying configurations can be coupled to the integrated power supply by the adapter cable assembly 118.

Alternatively, and with reference to FIGS. 2, 3 and 9, the docking assembly 16 can be a substantially rigid docking assembly secured to the first section 32 of the main body 14 of the cradle assembly 10. In one aspect, a portion of the docking assembly can extend outwardly beyond the first face 38 and/or the opposed second face 40 of the main body 14. On the portion of the docking assembly extending beyond the first face 38 of the main body 14, the docking assembly 16 can include the tablet port 126, such as, for example and without limitation, a USB, ARINC 429, Ethernet or RS232 port, for mating with the tablet interface. On the portion of the docking assembly 16 extending beyond the second face 40 of the main body 14, the docking assembly 16 can include the power supply port 128, such as a USB, ARINC 429, Ethernet or RS232 port, configured for mating with the integrated power supply 20. The docking assembly 16 can also be fitted with an auxiliary port 130 configured to provide an additional power source, USB, ARINC429, Ethernet, RS232 and the like for multiple tablet or electronic device. The docking assembly may optionally be provided to the cradle assembly 10.

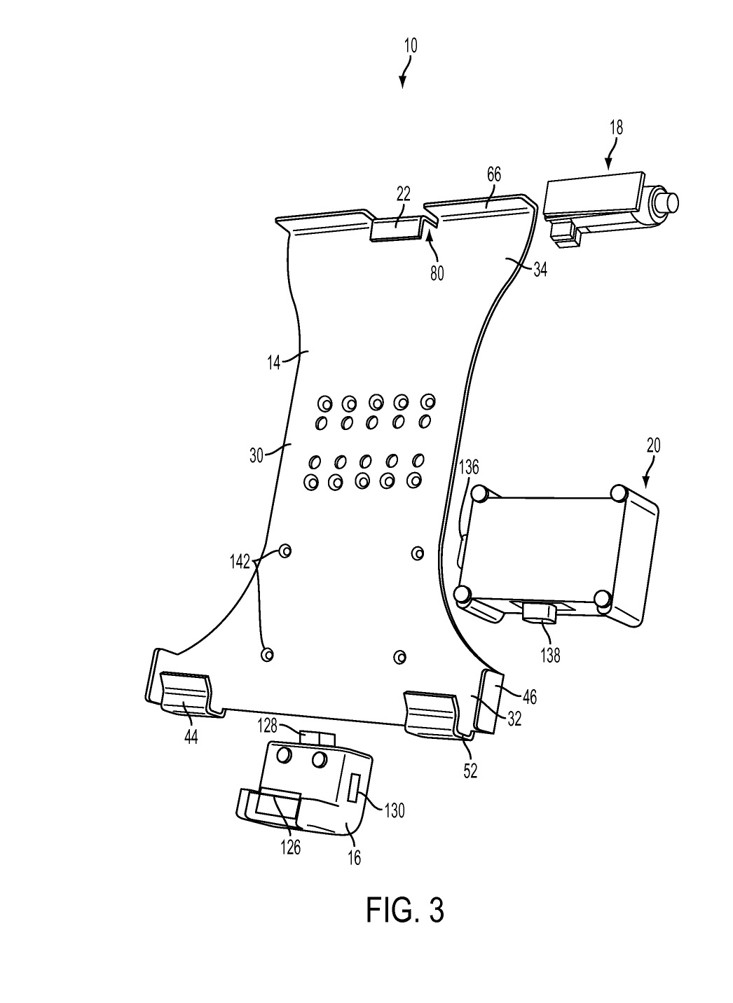

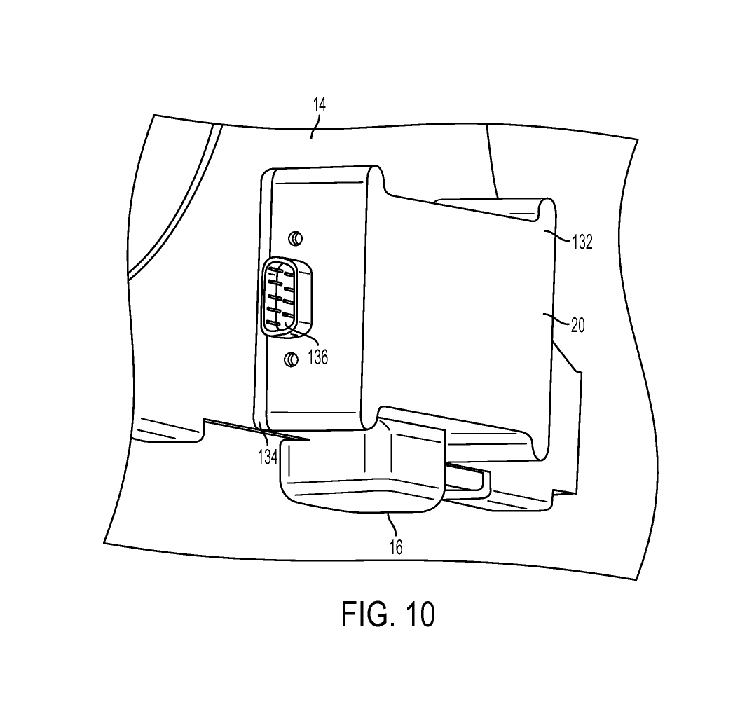

The integrated power supply 20, as illustrated in FIGS. 3, 5 and 10 may optionally be provided to power to the tablet 12. In one aspect, the integrated power supply 20 can comprise a battery and/or aircraft power configured to provide power at a predetermined voltage and amperage to the tablet. Obviously, the tablet may be charged independently prior to use in the cradle assembly 10. The integrated power supply 20 may provide, for example and without limitation, 5 vdc @ 3 amp max power. In another aspect, the integrated power supply further comprises a receptacle 132 and cover 134 as shown in FIG. 10 and can be secured to the main body 14 by appropriately positioned apertures 142, adhesives and/or fasteners such as screws or other mechanical means. The integrated power supply 20 can include an input port 136 which provides an input means for powering the integrated power supply 20. Optionally, the power supply port 128 of the docking assembly 16 may provide means for providing a hardwire connection to an external power supply, such as with a wire cable connected to a power source, e.g. ac source. In another aspect, the integrated power supply can comprise a number of additional ports, such as for example and without limitation, the auxiliary port 130.

In one aspect, the integrated power supply 20 can be constructed from aviation grade aluminum and houses high reliability DC-DC and EMI circuitry with current limit protection, short circuit protection, input under voltage lockout, soft start output and inhibit shutdown. The integrated power supply can be a 5 volt 3 amp power source. In one aspect, the integrated power supply 20 can have at least one port. For example, the integrated power supply 20 can have a first D-Sub mating connector or docking port 138 configured to couple the integrated power supply with the docking assembly 16. In another aspect, the input port 136 of the integrated power supply 20 can be a second port, wherein the input port 136 is configured to couple the integrated power supply with an input connection of 28 vdc, grounds, USB, ARINC429, Ethernet or RS232 from the aircraft systems. In another aspect, the integrated power supply can also have a manual power interrupt via an On/Off switch conveniently located within the cockpit. In yet another aspect, the integrated power supply 20 can also have a built in electronic inhibit feature as an alternate means of On/Off control. In a further aspect, the integrated power supply 20 can be used as a standalone power supply, and can mate with the docking assembly 16 when secured to the cradle assembly 10.

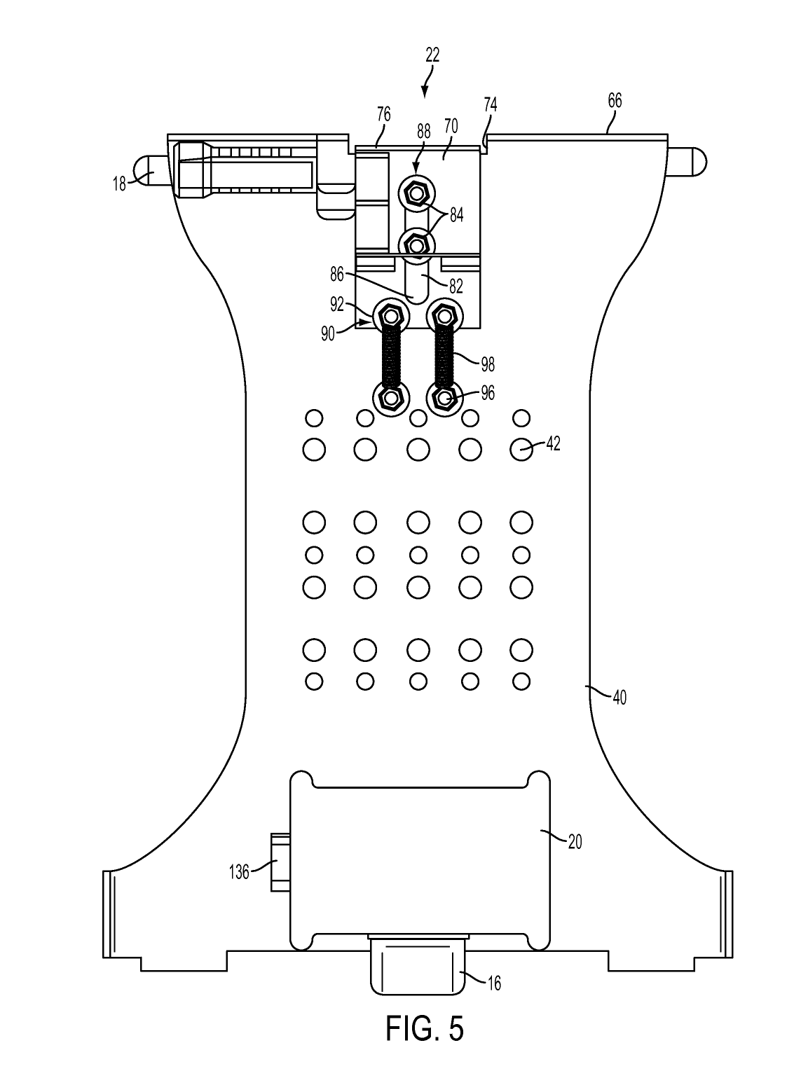

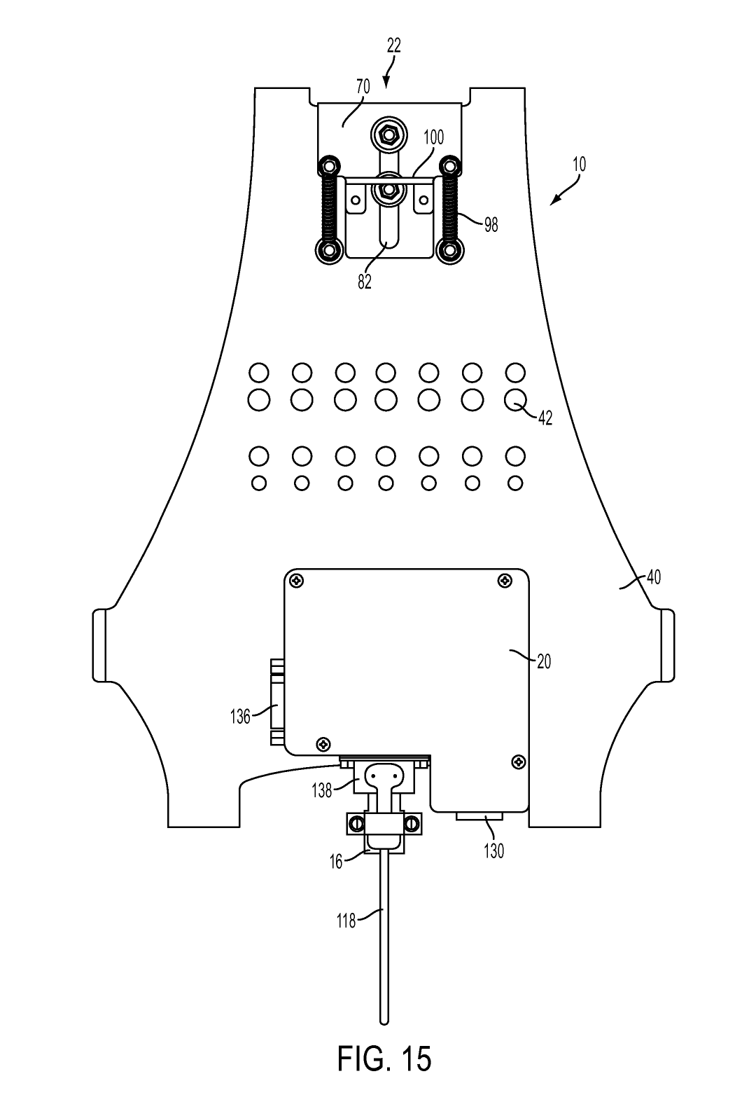

In another aspect, the integrated power supply 20 can be constructed to embody input port 136, power supply port 128 and/or auxiliary port 130 in a single housing or construction, providing power, USB, ARINC 429, RS232 and/or Ethernet to the tablet or electronic device via the docking assembly 16. As illustrated in FIG. 5, for example, the housing can be substantially rectangular. Optionally, in another example and with reference to FIG. 15, the housing can be substantially L-shaped. As can be appreciated, the housing can be any other shape in order to accommodate its environment and/or to position the plurality of ports as desired. For example, the L-shaped integrated power supply illustrated in FIG. 15 can position the docking port 138 and the auxiliary port 130 adjacent the distal edge 56 of the main body 14 for easy access to the ports.

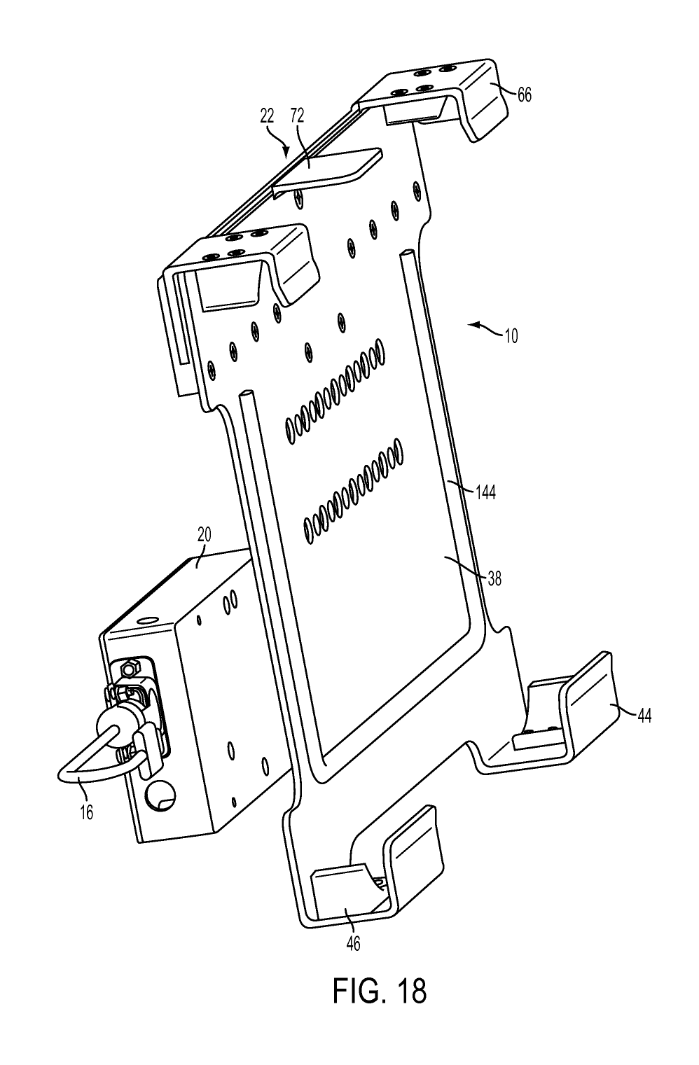

In one aspect and with reference to FIGS. 17 and 18, the cradle assembly 10 can further comprise at least one embossed reinforcing wall 144 positioned on a portion of the cradle assembly to provide additional structural integrity to the cradle assembly 10. For example, the embossed reinforcing wall 144 can be positioned on a portion of the main body 14 to limit or reduce flexing of the main body when subjected to a force.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the described invention, nor the claims which follow.

What is claimed is:

1. A cradle assembly for coupling a tablet to a mount with a fastener, the cradle assembly comprising:
a main body configured to couple to the mount, wherein the main body has a distal edge, an opposed proximal edge and a longitudinal axis extending therebetween, wherein the main body has a first face and an opposed second face, a first section, a second section, and a middle section positioned between the first and second sections, wherein the main body comprises at least one receptacle member positioned adjacent to and extending from the distal edge of the first face and configured to support a portion of the tablet;
a tablet retention assembly configured to secure the tablet within the cradle assembly, the tablet retention assembly comprising:
a slideable plate overlying at least a portion of the main body, wherein at least a portion of the slideable plate is sized and shaped to slide longitudinally in a guide groove defined substantially longitudinally in the main body, wherein a tablet chamber, configured to receive a portion of the tablet, is defined adjacent a proximal edge of the slideable plate, and wherein the slideable plate is slideable between a first position, in which the tablet chamber is a first distance from the distal edge of the main body, and a second position in which the tablet chamber is a second distance from the distal edge of the main body that is less than the first distance; and
at least one spring coupled to the main body and the slideable plate to bias the slideable plate towards the second position; and
a docking assembly configured to couple the tablet to at least one of a power source and a data interface.

2. The cradle assembly of claim 1, wherein the power source comprises an integrated power supply coupled to the second face of the main body.

3. The cradle assembly of claim 2, wherein the integrated power supply comprises a battery configured to provide power to the tablet.

4. The cradle assembly of claim 2, wherein the integrated power supply comprises aircraft power configured to provide at least one of power, USB, ARINC429, Ethernet and RS232 to the tablet.

5. The cradle assembly of claim 2, wherein the docking assembly comprises an adapter cable assembly configured to couple the tablet to the integrated power supply.

6. The cradle assembly of claim 1, wherein at least one of the first face and the second face is substantially planar.

7. The cradle assembly of claim 6, wherein the middle section of the main body has a lateral width that is narrower than a lateral width of at least one of the first section and the second section.

8. The cradle assembly of claim 1, wherein a plurality of body apertures are defined in the main body, and wherein the plurality of body apertures are positioned so that the fastener extends through a body aperture of the plurality of body apertures to couple the main body to the mount.

9. The cradle assembly of claim 1, wherein the at least one receptacle member of the main body comprises at least one longitudinally extending bottom extension member having a supporting surface positioned at a first angle relative to the first face.

10. The cradle assembly of claim 9, wherein the at least one receptacle member of the main body further comprises at least one retaining member coupled to and extending from the bottom extension member at a second angle relative to the bottom extension member, and wherein at least a portion of the at least one retaining member is configured to contact a viewing side of the tablet.

11. The cradle assembly of claim 10, wherein the main body further comprises at least one laterally extending retention member coupled to and extending from the proximal edge of the first face of the main body at a third angle relative to the first face.

12. The cradle assembly of claim 11, wherein the first angle, the second angle and the third angle are about 90 degrees.

13. The cradle assembly of claim 11, wherein at least one of the first angle, the second angle and the third angle is an acute angle.

14. The cradle assembly of claim 1, wherein the tablet retention assembly further comprises a handle coupled to a portion of the slideable plate configured to facilitate the sliding movement of the slideable plate relative to the main body.

15. The cradle assembly of claim 14, wherein the tablet retention assembly further comprises a slide limiting device configured to prevent the slideable plate from sliding past a predetermined position.

16. The cradle assembly of claim 15, wherein a passage is defined in the handle to accommodate a portion of the slide limiting device as the slideable plate slides relative to the main body.

17. The cradle assembly of claim 1, further comprising a locking assembly positioned on the second face of the main body, wherein the locking assembly is configured to restrict unauthorized removal of the tablet from the cradle assembly.

18. The cradle assembly of claim 17, wherein a lock receiving cavity is defined in a portion of the slideable plate, and wherein the locking assembly comprises a locking pin insertable into the lock receiving cavity when the slideable plate is in a predetermined position relative to the main body.

19. The cradle assembly of claim 18, wherein the locking pin is selectively activatable about and between a first, extended position in which the locking pin is inserted into the lock receiving cavity to restrict movement of the slideable plate relative to the main body, and a second, retracted position in which the locking pin is retracted from the lock receiving cavity and the slideable plate is slideable relative to the main body.

20. The cradle assembly of claim 19, wherein the locking assembly comprises a combination lock to selectively activate the locking pin.

21. The cradle assembly of claim 20, wherein the locking assembly comprises a key to selectively activate the locking pin.

22. A method of coupling a tablet having a first perimeter edge to a mount with a fastener, the method comprising:
providing a cradle assembly comprising:
a main body configured to couple to the mount, wherein the main body has a distal edge, an opposed proximal edge and a longitudinal axis extending therebetween, wherein the main body has a first face and an opposed second face, a laterally extending first section, a laterally extending second section, and a middle section positioned between the first and second sections, wherein the main body comprises at least one receptacle member positioned adjacent to and extending from the distal edge of the first face and configured to support a portion of the tablet;
a tablet retention assembly configured to secure the tablet within the cradle assembly, the tablet retention assembly comprising:
a slideable plate overlying a portion of the main body, wherein a portion of the slideable plate is sized and shaped to slide longitudinally in a guide groove defined in a portion of the main body, wherein a tablet chamber configured to receive a portion of the tablet is defined adjacent a proximal edge of the slideable plate, and wherein the slideable plate is slideable between a first position, in which the tablet chamber is a first distance from the distal edge of the main body, and a second position in which the tablet chamber is a second distance from the distal edge of the main body that is less than the first distance; and
at least one spring coupled to the main body and the slideable plate to bias the slideable plate towards the second position; and
a docking assembly configured to couple the tablet to at least one of a power source and a data interface;
urging the slideable plate to the second position;
positioning the tablet in the cradle assembly such that the first perimeter edge of the table contacts the at least one receptacle member; and
releasing the slideable plate such that the at least one spring biases the slideable plate to the second position to secure the tablet therein the cradle assembly.
